(19) United States
(12) Patent Application Publication
(10) Pub. No.: US 2006/0009556 A1
(43) Pub. Date: Jan. 12, 2006

(54) High gloss PET molding composition and articles made therefrom

(76) Inventor: Mengshi Lu, Hillsborough, NJ (US)

Correspondence Address: FERRELLS, PLLC, P. O. BOX 312, CLIFTON, VA, 20124-1706, US

(21) Appl. No.: 10/886,733

(22) Filed: Jul. 8, 2004

(51) Int. Cl. C08K 5/09; C08K 5/04

(52) U.S. Cl. 524/284; 524/394

(57) ABSTRACT

A polyethylene terephthalate injection molding composition includes: (a) from about 30 to about 70 weight percent of a polyethylene terephthalate matrix resin; (b) from about 3 to about 60 weight percent of a component selected from reinforcing agents, mineral fillers and mixtures thereof; (c) from 0 to about 25 weight percent of a polymeric impact modifier; (d) a nucleating agent selected from sodium and potassium salts of hydrocarbon carboxylic acids having from 20 to 35 carbon atoms; (e) a plasticizer selected from ethylene glycol esters of hydrocarbon carboxylic acids having from 6 to 35 carbon atoms; and optionally including lubricants, anti-oxidants, pigments, UV-stabilizers, mold release agents and mixtures thereof. The compositions exhibit superior surface when molded into parts, especially surface gloss.

### TECHNICAL FIELD

The present invention relates generally to polyethylene terephthalate injection molding compositions. More specifically, the present invention provides filled or reinforced PET compositions with elevated crystallization rates suitable for water-cooled tools which provides a superior surface finish to the molded parts.

### BACKGROUND

General background with respect to polyethylene terephthalate or “PET” based injection molding compositions is seen in U.S. Pat. No. 6,020,414 entitled “Method and Compositions for Toughening Polyester Resins” of Nelsen et al. in which there is disclosed impact modified PET compositions. The impact modifier comprises (a) an ethylene alkyl acrylate co-polymer, and (b) a second component selected from the terpolymer group consisting of ethylene/alkyl acrylate/glycidyl methacrylate; ethylene/alkyl acrylate/glycidyl acrylate; ethylene/alkyl methacrylate/glycidyl acrylate; and ethylene/alkyl methacrylate/glycidyl methacrylate.

Use of olefinic impact modifiers in polyester compositions to provide molded articles having improved mechanical properties, particularly improved impact resistance is well known. For example U.S. Pat. No. 4,172,859 entitled “Tough Thermoplastic Polyester Compositions” of Epstein claims polyester blends including ethylene/methyl acrylate/glycidyl acrylate polymers. The multi-phase thermoplastic compositions of Epstein consist essentially of one phase containing 60 to 90 percent by weight of a matrix resin of inherent viscosity of at least 0.35 deciliter/gram, and 1 to 40 percent by weight of at least one other phase containing particles of at least one random copolymer having a particle size in the range of 0.01 to 3.0 microns and being adhered to the polyester, the at least one random copolymer having a tensile modulus in the range of 1.0 to 20,000 psi, the ratio of the tensile modulus of the polyester matrix resin to tensile modulus of the at least one polymer being greater than 10 to 1.

U.S. Pat. No. 4,753,980 entitled “Toughened Thermoplastic Polyester Compositions” of Deyrup refers to polyester compositions comprising 60-97 weight percent of a polyester matrix (e.g., PBT and/or PET) and 3 to 40 weight percent of an ethylene copolymer.

U.S. Pat. No. 5,723,520 entitled “Polyester Molding Compositions and Articles Exhibiting Good Impact, Heat and Solvent Resistance” of Akkapeddi et al. describes molding compositions which are formed by first pre-reacting a thermoplastic polyester polymer or copolymer with a copolymer of ethylene and a glycidyl acrylate or methacrylate and then subsequently blending with a nucleating agent which is a Group I metal salt of a carboxylic acid to increase the crystallization rate of the polyester. At least one reinforcing component such as glass fibers or reinforcing fillers is used.

See also, U.S. Pat. No. Re. 32,334 entitled “Molding Resins” of Deyrup. Deyrup '334 refers to polyethylene terephthalate resin compositions containing filler or reinforcing agent, a selected sodium or potassium salt of a hydrocarbon acid or a salt of a selected organic polymer containing pendant carboxyl groups, and a selected low molecular weight organic ester, ketone, sulfone, sulfoxide, nitrile or amide. Articles molded from the compositions have high gloss when molded at temperatures below 110° C.

Other PET compositions are found in U.S. Pat. No. 4,983,660 entitled “Polyethylene Terephthalate Resin Composition” of Yoshida et al. and U.S. Pat. No. 5,277,864 entitled “Toughened Thermoplastic Polyester Compositions” of Blatz. In Yoshida et al. '660, there is disclosed a highly crystalline polyethylene terephthalate resin composition comprising a 100 parts by weight of a polyethylene terephthalate copolymer comprising ethylene terephthalate units as the main recurring units, (B) 2 to 200 parts by weight of a fibrous reinforcer, (C) 0.5 to 130 parts by weight of a nucleating agent, and (D) 0.1 to 60 parts by weight of a crystallization-promoting agent. In Blatz there is disclosed a toughened semi-crystalline thermoplastic polyester molding composition consisting essentially of a polyester resin and an ionomer of ethylene, a softening comonomer and unsaturated carboxylic acid.

U.S. Pat. No. 4,276,208 entitled “Glass Fiber-Reinforced Thermoplastic Polyester Composition” of Ogawa et al. is directed to a glass fiber-reinforced thermoplastic polyester composition comprising: (A) 100 parts by weight of polyethylene terephthalate having an intrinsic viscosity, measured at 35° C., in ortho-chlorophenol, of from 0.4 to 0.9, (B) from 0.05 to 3 parts by weight of a salt of montan wax, (C) from 5 to 200 parts by weight of glass fibers having an average length of at least 0.2 mm, and (D) from 0 to 5 parts by weight of an epoxy compound having at least two epoxy groups in the molecule.

U.S. Pat. No. 5,700,857 entitled “Flame Resistant Polyester Resin Composition” of Mukohyama is a polyester resin composition containing a polyalkylene oxide soft segment component, a plasticizer, a crystallization promoter, and a brominated flame retardant. The crystallization promoters include a sodium salt or potassium salt of a carboxylated organic polymer, such as the sodium salt or potassium salt of the copolymer of an olefin and acrylic acid or methacrylic acid and the copolymer of an aromatic olefin and maleic anhydride.

Despite advances in the art, there is a continuing need for PET molding compositions suitable for water-cooled tools operated at fast cycle times. Known PET compositions tend to have too low a crystallization rate, thus requiring long long cycle times, especially with respect to applications where surface appearance is important.

### SUMMARY OF INVENTION

The PET compositions of the invention exhibit surprising surface gloss and processability when formulated with a nucleating agent which is a salt of a C20-C35 carboxylic acid and a polyethylene glycol ester plasticizer. The inventive compositions have gloss values more than double that of conventional compositions having comparable crystallization rates.

Generally, the present invention is directed to a polyethylene terephthalate molding composition comprising: (a) from about 30 to about 70 weight percent of a polyethylene terephthalate matrix resin; (b) from about 3 to about 60 weight percent of a component selected from reinforcing agents, mineral fillers and mixtures thereof; (c) from 0 to about 25 weight percent of a polymeric impact modifier; (d) a nucleating agent selected from sodium and potassium salts of hydrocarbon carboxylic acids having from 20 to 35 carbon atoms; (e) a plasticizer selected from ethylene glycol esters of hydrocarbon carboxylic acids having from 6 to 35 carbon atoms; and optionally including lubricants, anti-oxidants, pigments, UV-stabilizers, mold release agents and mixtures thereof.

In one aspect of the invention the nucleating agent is selected from sodium or potassium salts of the following carboxylic acids: arachidic acids, henicosanoic acids, behenic acids, tricosanoic acids, lignoceric acids, pentacosanoic acids, cerotinic acids, heptacosanoic acids, montanic acids, melissic acids, lacceroic acids, ceromelissic acids, geddic acids, ceroplastic acids, and mixtures thereof. More specifically, the nucleating agent is selected from sodium salts of heptacosanoic acids, montanic acids, nonacosanoic acids, and mixtures thereof.

The nucleating agent is typically present in an amount of from about 0.25 to about 2 weight percent, typically from about 0.5 to about 1.5 weight percent.

The plasticizer may be selected from polyethylene glycol esters of the following acids: undecylic acids, lauric acids, tridecylic acids, myristic acids, pentadecanoic acids, palmitic acids, margaric acids, stearic acids, nondecylic acids, arachidic acids, henicosanoic acids, behenic acids, tricosanoic acids, lignoceric acids, pentacosanoic acids, cerotinic acids, heptacosanoic acids, montanic acids, nonacosanoic acids, melissic acids, lacceroic acids, ceromelissic acids, geddic acids, ceroplastic acids, and mixtures thereof.

Preferably, the plasticizer is a polyethylene glycol diester.

Preferably the ethoxy portion of the plasticizer has a molecular weight of from about 200 to about 2000; suitably about 600.

The nucleating agent may be selected from sodium salts of heptacosanoic acids, montanic acids, nonacosanoic acids while the plasticizer may be selected from polyethylene glycol diesters of the following acids: undecylic acids, lauric acids, and tridecylic acids. A preferred composition is one in which the nucleating agent is a sodium salt of montanic acids and the plasticizer is a polyethylene glycol diester of luaric acids.

In yet another aspect of the invention the plasticizer is present in an amount of from about 1 weight percent to about 6 weight percent, or from about 2 weight percent to about 4 weight percent.

In a typical composition, the polyethylene terephthalate matrix resin is present in an amount of from about 45 weight percent to about 55 weight percent. A mineral filler is present in an amount of from about 7.5 weight percent to about 15 weight percent, a reinforcing agent is present in an amount of from about 15 to about 45 weight percent such as 25 weight percent to about 35 weight percent, and the impact modifier is present in an amount of from about 1 to about 7.5 weight percent such as from 2 weight percent to about 4 weight percent.

Most preferably, the compositions include an impact modifier which is an ethylene/methyl acrylate copolymer or an ethylene/methyl acrylate/glycidyl methacrylate copolymer, or mixtures of the two.

The molded article of manufacture of the present invention will generally have a 60° surface gloss value of at least about 35, typically a 60° surface gloss value of at least about 45, and preferably a 60° surface gloss value of at least about 55.

In an article of manufacture prepared from a thermoplastic polyethylene terephthalate molding composition including a polyethylene terephthalate matrix resin at least one of a reinforcing agent or mineral filler, a nucleating agent and a plasticizer, the invention is directed to the improvement wherein the nucleating agent is selected from sodium and potassium salts of hydrocarbon carboxylic acids having from 20 to 35 carbon atoms, the plasticizer is selected from ethylene glycol esters of hydrocarbon carboxylic acids having from 6 to 35 carbon atoms, and the article has a surface gloss value at 60° of at least about 35.

Another method of the invention comprises: (a) preparing a molding composition including: i) from about 30 to about 70 weight percent of a polyethylene terephthalate matrix resin; ii) from about 3 to about 60 weight percent of a component selected from reinforcing agents, mineral fillers and mixtures thereof; iii) from 0 to about 25 weight percent of a polymeric impact modifier; iv) a nucleating agent selected from sodium and potassium salts of hydrocarbon carboxylic acids having from 20 to 35 carbon atoms; v) a plasticizer selected from ethylene glycol esters of hydrocarbon carboxylic acids having from 6 to 35 carbon atoms; and (b) injection molding the polyethylene terephthalate molding composition into a predetermined shape in a water-cooled tool, wherein molding surfaces of the tool are maintained at a temperature of about 110° or less and the article has a surface gloss value at 60° of at least about 35. The molding surfaces of the tool may be maintained at a temperature of about 105° C. or less such as 100° C. or less and the article may have a surface gloss value at 60° of at least about 45.

### DETAILED DESCRIPTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined, terminology as used herein is given its ordinary meaning. Percent, for example, refers to weight percent.

“Polyethylene terephthalate resin”, “PET”, “PET matrix resin” and so forth refers to a polymeric resin composed of at least about 85 percent of recurring ester units of terephthalic acid and ethylene glycol.

Thermally stable reinforcing agents are typically reinforcing fibers. Suitable reinforcing agents include, for example, glass fiber, carbon fiber, ceramic fiber, fibrous potassium titanate, iron whiskers, and the like. Glass is the most preferred. While fiber is the most preferred form for the reinforcing agent, other suitable forms may also be employed in the practice of the invention. Where reinforcing fibers are used, such fibers should normally have diameters between about 5 and about 30 microns, typically from 10-21 microns and preferably from 11-16 microns. Aspect ratios (ratio of length of fiber to diameter of fiber) are desirably at least about 5. The reinforcing fiber typically has a length of generally from 1-10 mm, preferably from 2-6 mm and more preferably from 3-5 mm. Glass fibers, where used, preferably have diameters between about 10 and about 15 microns and aspect ratios of at least about 20.

Suitable fillers include, but are not limited to, mica, talcum, clay, titanium dioxide, calcium carbonate and the like. There may be variants within the same filler type such as, for example, the muscovite type mica (supplied by KMG, Inc.), the phlogopite type mica (Suzorite, Inc.) and the like.

Nanofillers, that is, exfoliated minerals, are considered both reinforcing agents and mineral fillers for purposes of the present invention. Suitable nanofillers are exfoliated layered minerals including exfoliated clays such as montmorillonite, other exfoliated silicates and so forth as are known in the art.

“Polymeric impact modifier” and such terminology means and includes polymers used to toughen engineering resin compositions, including core-shell elastomers, ethylene/methacrylate copolymers, ionomers and so forth as are known in the art.

Also as part of the polyester resin of the polyester composition are conventional additives known to the art. Some of them include, for example, antioxidants, stabilizers, lubricants, nucleating agents, colorants, mold release agents, ultraviolet light stabilizers, and the like. Examples of suitable antioxidants include phosphites. Examples of suitable stabilizers include bis-phenol A based epoxy. Examples of suitable lubricants include olefinic waxes.

In preparing molded compositions of the invention, the reinforcing agent may be intimately blended into the polyethylene terephthalate molding composition by any suitable means such as by dry blending or melt blending, blending in extruders, heated rolls or other types of mixers. Melt-compounding by extrusion is preferred. The extrusion may be carried out in a suitable extruder such as for example a twin screw extruder with down-stream feeding capability. Many such extruders are commercially available such as, for example, the 40 mm Werner Pleiderer twin screw extruder. The extruder is fed with the resin composition and temperatures are kept at a suitable level, for example, the temperature may range 260-300 degrees Celsius. Likewise, in molding parts, barrel temperatures between about 260 and 290° C. are preferred. In a preferred embodiment, the molding composition of the invention is formed by extrusion and pelletized. Products of the invention are then produced by injection molding the pelletized extrudate.

The polyethylene terephthalate compositions of this invention containing the nucleating agent and plasticizer, when obtained by the end user, may be dried by any convenient method, re-melted and molded.

Unless otherwise indicated, the following test procedures are used to characterize the compositions and products of the invention:

| | |
|---|---|
| Flexural Properties | ISO 178 |
| DTUL | ISO 75 |
| Impact Strength | ISO 180 |
| Tensile Properties | ISO 527 |

These test methods may be found at www.iso.org. Unless otherwise indicated, the test method is that in effect on Jun. 1, 2004.

Surface Gloss Values are determined in accordance with ASTM D 523-89 (reissued 1999) using samples prepared as follows: a standard 4 inch disk is injection molded from compounded pellets using a barrel temperature of about 260° C.-280° C. and a nozzle temperature of about 285° C. into a mold maintained at about 95° C. Preferably black pigmented samples are used.

Similarly, test bars for physical properties and deflection temperature prepared by injection molding the bars into a water-cooled tool maintained at 95° C., wherein the nozzle temperature is about 285° C. and the barrel temperature from 260° C. to 280° C.

The following examples illustrate preferred compositions and methods of the invention. These examples are illustrative only and do not limit the scope of the invention. All percentages are by weight, unless otherwise indicated.

### EXAMPLE 1

### Comparative Examples A, B, C

A variety of nucleating agent/plasticizer combinations were studied in a polyethylene terephthalate matrix resin with a mineral filler, reinforcing agent, and impact modifier. The indicated nucleating agent compositions were incorporated into compositions at the amounts indicated in Table 1 by melt-compounding.

In Table 1, Impact Modifier 1 was an ethylene/methyl acrylate copolymer, Lotryl 29MA03 and Impact Modifier 2 was an ethylene/methyl acrylate/glycidyl methacrylate copolymer, Lotader AX8900, both available from Atofina Chemicals. The antioxidant employed was Irganox® B215 (Ciba-Geigy). Composition A was a commercially available, mineral-filled and reinforced PET molding composition.

TABLE 1
Test Compositions

Examples

| | A | B | C | 1 |
|---|---|---|---|---|
| PET (virgin) | * | | 50.1 | 50.1 |
| PET (Post Consumer) | * | 51.7 | | |
| Fiberglass (PPG 3540) | * | 30 | 30 | 30 |
| Mica (Suzorite 150S) | * | 10 | 10 | 10 |
| Impact Modifier 1 | * | 3.2 | 3.2 | 3.2 |
| Impact Modifier 2 | * | 0.8 | 0.8 | 0.8 |
| PEG Dilaurate Plasticizer | * | | | 3 |
| (Uniplex 810) | | | | |
| Sulfononamide Plasticizer | * | | 3 | |
| (Uniplex 413) | | | | |
| Oxidized Polyolefin (AC629A) | * | 2 | | |
| Antioxidant | * | 0.4 | 0.4 | 0.4 |
| Sodium Montanate | * | 0.4 | 1 | 1 |
| (Licomont NaV101) | | | | |
| Color Concentrate | | 1.5 | 1.5 | 1.5 |

*not known

The melting temperature, T_{M1} (° C.), heat of fusion (first heating), ΔH₁ (J/g) and temperature at maximum crystallization rate, Tc (° C.) for Example 1 and Comparative Examples A, B and C appear in Table 2 below. These quantities were measured using a differential scanning calorimeter wherein the sample was heated from ambient temperature to 280° C. at a rate of 10° C. per minute. The temperature was held at 280° C. for five minutes before the sample was cooled at the same rate. The heat of fusion and melting temperature is measured on the first heating, while the temperature at which maximum crystallization rate occurs was determined as the sample was cooled. This latter quantity is indicative of relative crystallization rates in a mold.

TABLE 2
Melting, Crystallization Temperatures

Examples

| | A | B | C | 1 |
|---|---|---|---|---|
| T_{M1} (° C.) | 252.9 | 245.9 | 251.3 | 254.6 |
| ΔH₁ (J/g) | 22.0 | 23.8 | 24.8 | 27.5 |
| Tc (° C.) | 217.0 | 194.4 | 214.0 | 217.8 |

Differential scanning calorimetry shows that the temperature at which crystallization rate is greatest increased from 194.4° C. for the composition containing a conventional nucleant/plasticizer combination to 217.8° C. for a composition with high molecular weight acid salt/PEG ester combination. This data shows that for a given base composition, the rate of crystallization can be increased dramatically by the inventive nucleant/plasticizer combination. The large increase in crystallization rate is also inferred from the gloss data reported in Table 4 below.

The invention uses a combination of 1% Licomont NaV101 and 3% Uniplex 810. Licomont NaV101 is the sodium salt of long chain carboxylic acids (chain length: predominately C₂₈-C₃₂) and is also supplied as white powder.

The substantial increase in crystallization temperature of the present invention is highly desirable in order to enable a greater differential between the mold temperature and the temperature of the molding composition.

Properties for test bars injection molded from compositions of A, B and Example 1 of Table 1 appear below in Table 3.

TABLE 3
Physical Properties, Heat Resistance

| | Examples | | |
|---|---|---|---|
| Property | A | B | 1 |
| Tensile Strength at Break | 110.7 | 124.3 | 106.5 |
| (MPa) | | | |
| Break Elongation (%) | 1.8 | 2.1 | 1.6 |
| Tensile Modulus (Gpa) | 12.3 | 11.7 | 11.7 |
| Flex Strength (MPa) | 174.0 | 191.9 | 163.5 |
| Flex Modulus (GPa) | 12.6 | 11.5 | 11.7 |
| Notched Izod (ft-lb/in) | 7.3 | 9.1 | 7.6 |
| DTUL @ 1.8 MPa (° C.) | 222.8 | 213.0 | 228.1 |

As will be appreciated from the foregoing, compositions of the invention exhibit comparable properties and elevated crystallization rates, enabling faster processing in a water-cooled mold. The injection-molded products also exhibit surprising surface gloss as seen in Table 4 below.

TABLE 4
Surface Gloss (ASTM D523-89)

| Example | Surface Gloss Value |
|---|---|
| 1 | 61.3 |
| A | 26.5 |
| B | 11.2 |

While the invention has been described in connection with several examples, modifications to these examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. A polyethylene terephthalate molding composition comprising:
a) from about 30 to about 70 weight percent of a polyethylene terephthalate matrix resin;
b) from about 3 to about 60 weight percent of a component selected from reinforcing agents, mineral fillers and mixtures thereof;
c) from 0 to about 25 weight percent of a polymeric impact modifier;
d) a nucleating agent selected from sodium and potassium salts of hydrocarbon carboxylic acids having from 20 to 35 carbon atoms;
e) a plasticizer selected from ethylene glycol esters of hydrocarbon carboxylic acids having from 6 to 35 carbon atoms;
and optionally including lubricants, anti-oxidants, pigments, UV-stabilizers, mold release agents and mixtures thereof.

2. The composition according to claim 1, wherein the nucleating agent is selected from sodium or potassium salts of the following carboxylic acids: arachidic acids, henicosanoic acids, behenic acids, tricosanoic acids, lignoceric acids, pentacosanoic acids, cerotinic acids, heptacosanoic acids, montanic acids, melissic acids, lacceroic acids, ceromelissic acids, geddic acids, ceroplastic acids, and mixtures thereof.

3. The composition according to claim 1, wherein the nucleating agent is selected from sodium salts of heptacosanoic acids, montanic acids, nonacosanoic acids, and mixtures thereof.

4. The composition according to claim 1, wherein the nucleating agent is present in an amount of from about 0.25 to about 2 weight percent.

5. The composition according to claim 1, wherein the nucleating agent is present in an amount of from about 0.5 to about 1.5 weight percent.

6. The composition according to claim 1, wherein the plasticizer is selected from polyethylene glycol esters of the following acids:
undecylic acids, lauric acids, tridecylic acids, myristic acids, pentadecanoic acids, palmitic acids, margaric acids, stearic acids, nondecylic acids, arachidic acids, henicosanoic acids, behenic acids, tricosanoic acids, lignoceric acids, pentacosanoic acids, cerotinic acids, heptacosanoic acids, montanic acids, nonacosanoic acids, melissic acids, lacceroic acids, ceromelissic acids, geddic acids, ceroplastic acids, and mixtures thereof.

7. The composition according to claim 1, wherein the plasticizer is a polyethylene glycol diester.

8. The composition according to claim 1, wherein the nucleating agent is selected from sodium salts of heptacosanoic acids, montanic acids, nonacosanoic acids and the plasticizer is selected from polyethylene glycol diesters of the following acids: undecylic acids, lauric adcids, and tridecylic acids.

9. The composition according to claim 1, wherein the nucleating agent is a sodium salt of montanic acids and the plasticizer is a polyethylene glycol diester of luaric acids.

10. The composition according to claim 1, wherein the plasticizer is present in an amount of from about 1 weight percent to about 6 weight percent.

11. The composition according to claim 1, wherein the plasticizer is present in an amount of from about 2 weight percent to about 4 weight percent.

12. The composition according to claim 1, wherein the polyethylene terephthalate matrix resin is present in an amount of from about 45 weight percent to about 55 weight percent.

13. The composition according to claim 1, wherein a mineral filler is present in an amount of from about 7.5 weight percent to about 15 weight percent.

14. The composition according to claim 1, wherein a reinforcing agent is present in an amount of from about 15 to about 45 weight percent.

15. The composition according to claim 1, wherein a reinforcing agent is present in an amount of from about 25 weight percent to about 40 weight percent.

16. The composition according to claim 1, comprising a nanofiller.

17. The composition according to claim 1, wherein an impact modifier is present in an amount of from about 1 to 7.5 weight percent.

18. The composition according to claim 1, wherein an impact modifier is present in an amount of from about 2 weight percent to about 4 weight percent.

19. The composition according to claim 1, comprising an ethylene/methyl acrylate copolymer impact modifier.

20. The composition according to claim 1, comprising an ethylene/methyl acrylate/glycidyl methacrylate copolymer impact modifier.

21. The composition according to claim 1, molded into an article of manufacture having a 60° surface gloss value of at least about 35.

22. The composition according to claim 1, molded into an article of manufacture having a 60° surface gloss value of at least about 45.

23. The composition according to claim 1, molded into an article of manufacture having a 60° surface gloss value of at least about 55.

24. In an article of manufacture prepared from a thermoplastic polyethylene terephthalate molding composition including a polyethylene terephthalate matrix resin at least one of a reinforcing agent or mineral filler, a nucleating agent and a plasticizer, the improvement wherein the nucleating agent is selected from sodium and potassium salts of hydrocarbon carboxylic acids having from 20 to 35 carbon atoms, the plasticizer is selected from ethylene glycol esters of hydrocarbon carboxylic acids having from 6 to 35 carbon atoms, and the article has a surface gloss value at 60° of at least about 35.

25. A method of preparing an article of manufacture form a thermoplastic molding composition comprising:
a) preparing a molding composition including:
i) from about 30 to about 70 weight percent of a polyethylene terephthalate matrix resin;
ii) from about 3 to about 60 weight percent of a component selected from reinforcing agents, mineral fillers and mixtures thereof;
iii) from about 0 to about 25 weight percent of a polymeric impact modifier;
iv) a nucleating agent selected from sodium and potassium salts of hydrocarbon carboxylic acids having from 20 to 35 carbon atoms;
v) a plasticizer selected from ethylene glycol esters of hydrocarbon carboxylic acids having from 6 to 35 carbon atoms; and
b) injection molding the polyethylene terephthalate molding composition into a predetermined shape in a water-cooled tool, wherein molding surfaces of the tool are maintained at a temperature of about 110° or less and the article has a surface gloss value at 60° of at least about 35.

26. The method of claim 25, wherein the molding surfaces of the tool are maintained at a temperature of about 105° C. or less.

27. The method of claim 25, wherein the molding surfaces of the tool are maintained at a temperature of about 100° C. or less.

28. The method of claim 25, wherein the article has a surface gloss value at 60° of at least about 45.
